(19) United States
(12) Patent Application Publication
(10) Pub. No.: US 2026/0304075 A1
(43) Pub. Date: Oct. 1, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: YUICHI YAMAKAWA, Chiba (JP)

(21) Appl. No.: 19/570,027

(22) Filed: Mar. 17, 2026

(30) Foreign Application Priority Data
Mar. 26, 2025 (JP) 2025-051947

(51) Int. Cl. H04W 4/33; H04W 52/28; H04W 52/36; H04W 84/12

(52) U.S. Cl. CPC H04W 4/33; H04W 52/283; H04W 52/367; H04W 84/12

(57) ABSTRACT

A communication apparatus is configured to receive mounting of an accessory to the communication apparatus, and control a communication parameter in accordance with a predetermined accessory mounted to the communication apparatus.

### BACKGROUND

### Field of the Technology

The present disclosure relates to a wireless communication apparatus and a program therefor in a wireless local area network (LAN) complying with Institute of Electrical and Electronics Engineers (IEEE) 802.11.

### Description of the Related Art

In recent years, with an increase in the amount of data to be communicated, development of communication techniques such as a wireless LAN has been progressing. As a major communication standard for the wireless LAN, the Institute of Electrical and Electronics Engineers (IEEE) 802.11 standard series is known. The IEEE 802.11 standard series includes standards such as IEEE 802.11a/b/g/n/ac/ax. For example, in IEEE 802.11ax, a technique that improves a communication speed under congested conditions, in addition to high peak throughput of 9.6 gigabits per second (Gbps) at a maximum, is standardized by using Orthogonal Frequency Division Multiple Access (OFDMA).

In these standards, wireless communication is performed by emitting radio waves in predetermined frequency bands such as a 2.4 GHz band, a 5 GHz band, and a 6 GHz band into the atmosphere. However, these frequency bands are used not only by the wireless LAN of the IEEE 802.11 standards but also by other communications. Thus, there is a concern that interference with the other communications may occur. Therefore, depending on each country, regulations exist such that usable channels are limited or transmission power is restricted for outdoor use.

Furthermore, with the proliferation of smartphones, wireless LAN devices that can be used both outdoors and indoors tend to increase in number. However, as described above, the usable channels and the maximum transmission power are different between indoors and outdoors. Thus, a technique has been proposed in which a wireless LAN device is always operated with strictly limited settings based on regulations, or in which channels to be used are limited in accordance with a result of indoor/outdoor determination (see Japanese Patent Laid-Open No. 2003-318915).

Along with improvement in battery performance, the number of wireless LAN apparatuses that operate indoors on battery power is increased, and there are cases where it is difficult to determine whether the location is indoors or outdoors. In a case where the indoor/outdoor determination cannot be correctly performed, the wireless LAN apparatus is inevitably operated in a state where the channel and the transmission power are restricted more than originally required even indoors. A method in which indoor use or outdoor use may be selected by a user is also possible; however, it is necessary for the user to select indoor use or outdoor use after the user understands legal regulations, and if the user makes an incorrect selection, there is a concern that the wireless LAN apparatus may be operated with settings not based on regulations.

### SUMMARY

It is desirable that the indoor/outdoor determination can be automatically performed. According to an aspect of the present disclosure, a communication apparatus includes a mounting reception unit configured to receive mounting of an accessory to the communication apparatus, and a communication control unit configured to control a communication parameter in accordance with a predetermined accessory mounted to the communication apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an outline of a wireless communication system.

FIG. 2 is a diagram illustrating a hardware configuration example of a communication apparatus.

FIGS. 3A, 3B, 3C, and 3D are diagrams each illustrating an example of an accessory.

FIG. 4 is a flowchart when an access point (AP) function is started up according to a first embodiment.

FIG. 5 is a flowchart of processing for setting a channel and maximum transmission power according to the first embodiment.

FIG. 6 is a flowchart of station (STA) startup processing according to a second embodiment.

FIG. 7 is a flowchart of processing for setting maximum transmission power according to the second embodiment.

### DESCRIPTION OF THE EMBODIMENTS

Hereinafter, embodiments will be described in detail with reference to the accompanying drawings. Note that the embodiments described below are not intended to limit the disclosure according to the claims. Although a plurality of features are described in the embodiments, not all of the plurality of features are essential to the disclosure, and the plurality of features may be combined as desired. Further, in the accompanying drawings, the same reference numerals are assigned to the same or similar components, and redundant description thereof is omitted.

### System Configuration

### First Embodiment

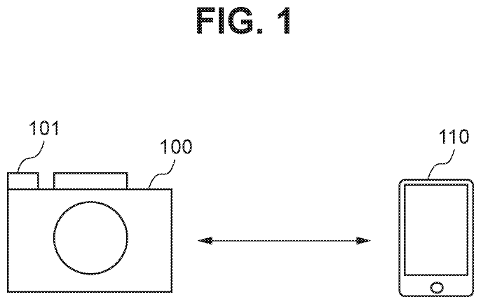

FIG. 1 illustrates an outline of a network according to a first embodiment. A wireless communication system includes two or more communication apparatuses. In the present embodiment, the wireless communication system includes a communication apparatus 100 and a communication apparatus 110.

The communication apparatus 100 is a wireless communication apparatus capable of performing wireless communication complying with the Institute of Electrical and Electronics Engineers (IEEE) 802.11 standard series. In the present embodiment, the communication apparatus 100 has an access point (AP) function capable of performing wireless communication complying with the IEEE 802.11 standard series. The communication apparatus 100 may also have a station (STA) function and a Wi-Fi Direct® function in addition to the access point function. In the present embodiment, the communication apparatus 100 is a camera, but is not limited thereto, and may be, for example, a head-mounted display including a display unit for providing visual information.

Further, the communication apparatus 100 includes a connection terminal 101 to which an accessory for extending functionality of the communication apparatus 100 can be connected. The accessory refers to an auxiliary device or an attachment mounted on the communication apparatus 100. For example, in a case where the communication apparatus 100 is a camera, the accessory refers to a global positioning system (GPS) unit that records position information at the time of imaging, or the like.

The communication apparatus 100 checks information about the accessory connected to the connection terminal 101, and then operates the access point function.

The communication apparatus 110 is also a wireless communication apparatus capable of performing wireless communication complying with the IEEE 802.11 standard series. In the present embodiment, the communication apparatus 110 has a station (STA) function capable of performing wireless communication complying with the IEEE 802.11 standard series. The communication apparatus 110 can be wirelessly connected to and communicate with the communication apparatus 100 operating as an access point based on the IEEE 802.11 standard series.

### Apparatus Configuration

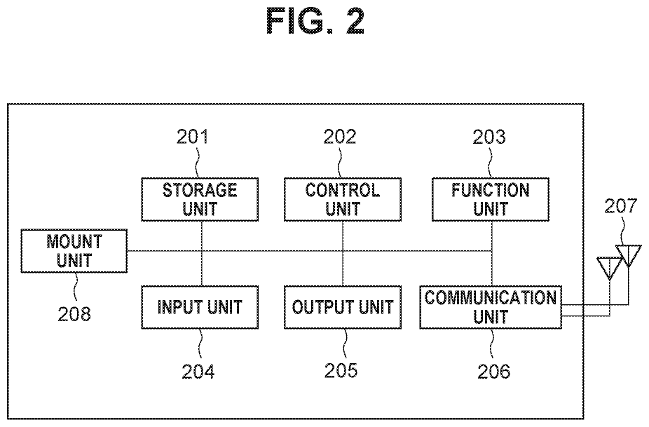

FIG. 2 illustrates a hardware configuration example of the communication apparatus 100 according to the present embodiment. The communication apparatus 100 includes a storage unit 201, a control unit 202, a function unit 203, an input unit 204, an output unit 205, a communication unit 206, an antenna 207, and a mount unit 208. A plurality of antennas may be provided. The storage unit 201 includes one or more memories such as a read-only memory (ROM) and a random access memory (RAM), and stores computer programs for performing various kinds of operation described below, and various kinds of information such as a communication parameter for the wireless communication. As the storage unit 201, in addition to the memories such as the ROM and the RAM, a storage medium such as a flexible disk, a hard disk, an optical disc, a magneto-optical disc, a compact disc read-only memory (CD-ROM), a compact disc recordable (CD-R), a magnetic tape, a nonvolatile memory card, and a digital versatile disc (DVD) may be used. The storage unit 201 may include a plurality of memories and the like. The storage unit 201 can store setting information input to the apparatus from a user, a remaining amount of a battery provided in the apparatus, and information about a state of the apparatus such as whether a power-saving operation is being executed.

The control unit 202 includes one or more processors such as a central processing unit (CPU) and a microprocessor unit (MPU), and controls the entire communication apparatus 100 by executing a computer program stored in the storage unit 201. The control unit 202 may control the entire communication apparatus 100 through cooperation between the computer programs and an operating system (OS) stored in the storage unit 201. Further, the control unit 202 generates data and signals (wireless frames) to be transmitted in communication with other communication apparatuses. The control unit 202 may include a plurality of processors such as a multi-core processor, and may control the entire communication apparatus 100 by the plurality of processors. Further, the control unit 202 controls the function unit 203 to perform predetermined processing such as wireless communication, imaging, printing, and photographing. The function unit 203 is hardware that enables the communication apparatus 100 to perform the predetermined processing.

Further, the control unit 202 determines whether a location of the communication apparatus 100 is outdoors, or determines whether the location of the communication apparatus 100 is indoors, based on an accessory that the mount unit 208 described below is configured to receive mounting or connection thereof. Determination as to whether the location of the communication apparatus 100 is outdoors or indoors performed in this manner by the control unit 202 is collectively referred to as indoor/outdoor determination.

The input unit 204 receives various kinds of operation from the user. The output unit 205 performs various kinds of output to the user via a monitor screen and a speaker. The output by the output unit 205 may include display on the monitor screen, audio output by the speaker, vibrational output, and the like. Both the input unit 204 and the output unit 205 may be implemented by one module such as a touch panel.

The communication unit 206 is a communication control unit that controls wireless communication complying with the IEEE 802.11 standards, and for example, transmits a wireless frame complying with the IEEE 802.11 standards.

In a case where the communication apparatus 100 supports the Near Field Communication (NFC) standard, the Bluetooth® standard, and the like in addition to the IEEE 802.11 standards, the communication unit 206 may also control wireless communication complying with these communication standards. The communication unit 206 controls the antenna 207 to transmit and receive signals for wireless communication generated by the control unit 202. The communication apparatus 100 communicates data such as image data, document data, and video data with a counterpart communication apparatus via the communication unit 206. The antenna 207 may be configured separately from the communication unit 206, or the antenna 207 and the communication unit 206 may be integrally configured as one module.

The antenna 207 is an antenna capable of performing communication in a 2.4 GHz band, a 5 GHz band, a 6 GHz band, and the like. In the present embodiment, two or more antennas may be provided. In a case where the communication unit 206 includes a plurality of communication portions, antennas corresponding to the respective communication portions may be provided. Alternatively, antennas for respective frequency bands may be provided.

The mount unit 208 is a mounting reception unit that receives mounting of an accessory to the communication apparatus 100, and performs mounting of the accessory to the connection terminal 101. Further, the mount unit 208 performs detection and connection of the accessory at the connection terminal 101. The detection method may be a method of performing electric communication with the accessory to confirm a type of the accessory, or a method of detecting the accessory by a physical switch. The connection method may include an electric connection and a physical connection.

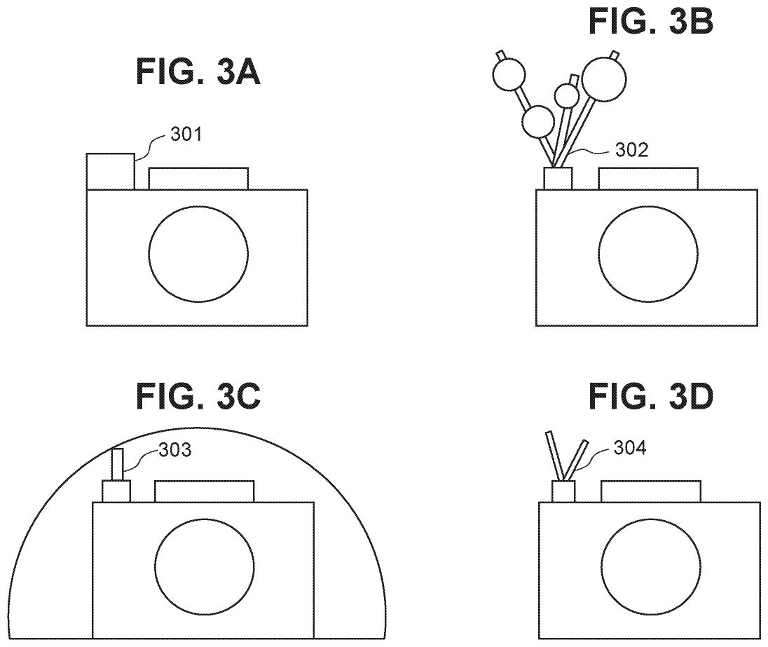

FIGS. 3A to 3D illustrate specific examples of the accessory connected to the communication apparatus 100 via the connection terminal 101. The accessory can extend functionality of the communication apparatus 100 or protect the communication apparatus 100 by being connected to the communication apparatus 100.

For example, an accessory 301 illustrated in FIG. 3A is an example of a GPS unit. In a case where the communication apparatus 100 has a camera function and the GPS unit is mounted, GPS position information at a timing at which imaging is performed can be recorded as a parameter of an imaging location in a photograph. To acquire the position information by GPS, it is necessary that the communication apparatus 100 be outdoors where an artificial satellite is visible. Therefore, when the GPS unit is mounted, it is possible to determine that the communication apparatus 100 is used outdoors. In a case where the GPS unit is physically mounted but the GPS function can be turned on/off, the communication apparatus 100 may be determined to be used outdoors when the GPS function is turned on.

An accessory 302 illustrated in FIG. 3B is an example of a motion capture sensor. In a case where the communication apparatus 100 is a head-mounted display and the motion capture sensor that is the accessory 302 is mounted, it is possible to measure motion and a position of the head-mounted display. In a motion capture system, a plurality of marker detectors acquires a marker that is the motion capture sensor from various positions including an upper position, thereby measuring a movement and a position of the marker. Outdoors, it is difficult to arrange the marker detectors at upper positions, and it is difficult to detect the marker due to sunlight and the like. Thus, the motion capture system is used indoors. Accordingly, when the motion capture sensor is mounted, it is possible to determine that the communication apparatus 100 is used indoors.

An accessory 303 illustrated in FIG. 3C is an example of a wind-and-rain countermeasure unit. The wind-and-rain countermeasure unit is a unit mounted to protect the communication apparatus 100 from wind, rain, and the like, and may be, for example, a waterproof unit, a dustproof unit, a rainproof unit, a cold-protection unit, a windproof unit, or a protective unit having any one or more of such functions. In a case where the wind-and-rain countermeasure unit is mounted, it is possible to determine that the communication apparatus 100 is used outdoors.

An accessory 304 illustrated in FIG. 3D is an example of an external antenna unit. Although the communication apparatus 100 is originally capable of wirelessly communicating with an external apparatus even without the external antenna unit, the external antenna unit is used to extend the antenna function of the communication apparatus 100, for example, in a case where radio waves are transmitted over a farther distance by increasing directivity. In such a use case, it can be determined that the communication apparatus 100 is used outdoors.

### Flow of Processing

Subsequently, a flow of processing performed by the communication apparatus 100 is described.

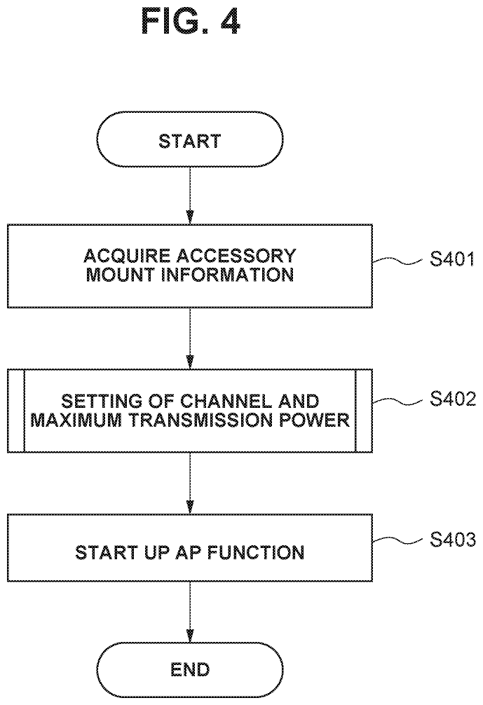

In the present embodiment, an example in which the communication apparatus 100 starts up the access point (AP) function is described. FIG. 4 is a flowchart in which the communication apparatus 100 starts up the access point function. In step S401, information on an accessory connected to the mount unit 208 is acquired.

The information on the accessory indicates a type and an operation state of the accessory connected to the mount unit 208. By step S401, it is possible to know whether the accessory as described with reference to FIGS. 3A to 3D is connected. In step S402, setting of a channel operable as the access point function and setting of a maximum transmission power are performed in accordance with the mounted accessory. Details of the processing for setting the channel and the maximum transmission power are described below. In step S403, the access point function is started up based on setting values set in step S402.

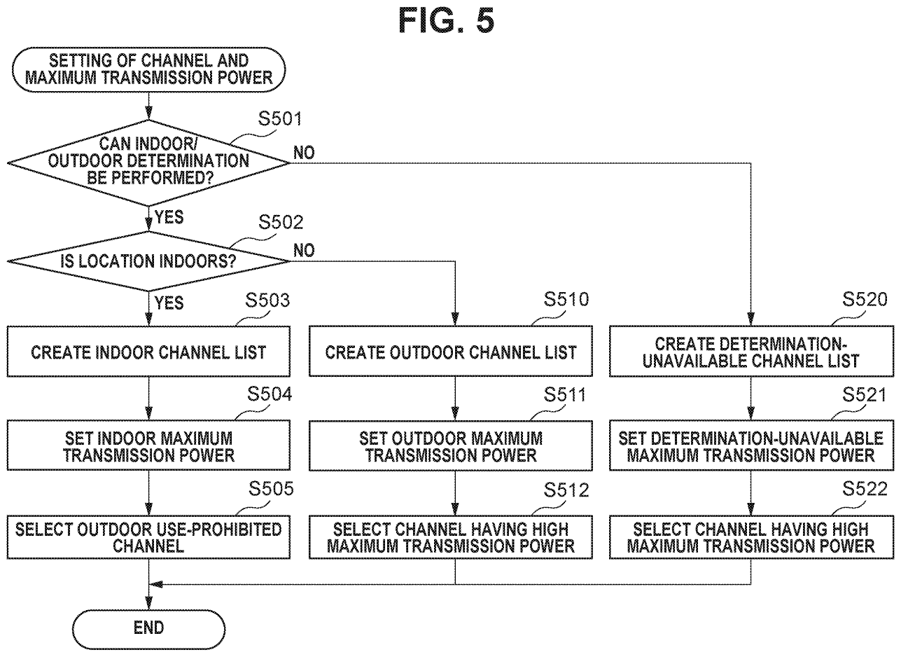

Subsequently, the processing for setting the channel and the maximum transmission power in step S402 is described in detail with reference to FIG. 5. In the processing for setting the channel and the maximum transmission power, in step S501, it is checked whether the indoor/outdoor determination can be performed based on the accessory mount information acquired in step S401. For example, in a case where the accessory is the one relating to the indoor/outdoor determination as described in FIGS. 3A to 3D, the indoor/outdoor determination can be performed (YES in step S501), and the processing proceeds to step S502. However, in a case where no accessory is mounted or an accessory for which the indoor/outdoor determination cannot be performed (e.g., an external strobe or an external flash) is mounted, it is determined that the indoor/outdoor determination cannot be performed (NO in step S501), and the processing proceeds to step S520. In a case where it is determined in step S501 that the indoor/outdoor determination can be performed, in step S502, it is determined whether the location of the communication apparatus 100 is indoors or outdoors based on the accessory mount information. In the examples illustrated in FIGS. 3A to 3D, in a case where the motion capture sensor is mounted, it is determined that the location is indoors, and in a case where the GPS unit, the wind-and-rain countermeasure unit, or the external antenna is mounted, it is determined that the location is outdoors. This is illustrative, and the indoor/outdoor determination is performed in accordance with the mounted accessory. In a case where it is determined that the location is indoors (YES in step S502), the processing proceeds to step S503. In a case where it is determined that the location is outdoors (NO in step S502), the processing proceeds to step S510. In step S503, an indoor channel list is created since it has been determined that the communication apparatus 100 is used indoors. In Japan, channels in which the wireless LAN can be used indoors are the 2.4 GHz band (channels 1 to 13), W52 (channels 36 to 48), W53 (channels 52 to 64), and W56 (channels 100 to 144) of the 5 GHz band, and UNII-5 (channels 1 to 93) of the 6 GHz band. In Japan, the number of wireless LAN channels that can be used indoors is larger than the number of wireless LAN channels that can be used outdoors. In step S504, indoor maximum transmission power is set for channels set for indoor use. This is because, depending on the country, a permitted maximum transmission power value is different between indoors and outdoors (e.g., in the case of 6 GHz band in the U.S., the transmission power value is required to be lower for indoor use compared with that for outdoor use). In step S505, when the communication apparatus 100 is started up as the access point, an outdoor use-prohibited channel is preferentially selected (e.g., W53 or W52 in Japan). This is because it is unlikely that an access point not subjected to the indoor/outdoor determination preferentially uses the outdoor use-prohibited channel, and thus the outdoor use-prohibited channel is considered to be relatively less congested. Note that preferentially selecting a channel mentioned herein refers to an access point automatically selecting a channel without displaying channel selection to the user, or setting a channel as a default channel when allowing the user to select a channel to use. In a case where it is determined that the location is indoors in step S502, setting of the channel and the transmission power appropriate for indoor use can be performed in the above-described manner.

In a case where it has been determined that the communication apparatus 100 is used outdoors in step S502, an outdoor channel list is created in step S510. In Japan, channels usable outdoors for a wireless LAN access point are the 2.4 GHz band (channels 1 to 13), W56 (channels 100 to 144) of the 5 GHz band, and UNII-5 (channels 1 to 93) of the 6 GHz band. However, there may be exceptions such as conditional use and prohibition of use in the air. The number of channels usable outdoors is less than the number of channels usable indoors. In step S511, setting of the outdoor maximum transmission power is performed for the channels set for outdoors. In step S512, a channel to be used when the communication apparatus 100 is started up as the access point is selected. A configuration may be employed in which, as a condition of a channel that is preferentially selected at the time of channel selection, a channel having high maximum transmission power among the usable channels is preferentially selected. This is because the maximum transmission power value in step S511 is different from the indoor maximum transmission power value.

In the case where it is determined that the indoor/outdoor determination cannot be performed in step S501, in step S520, a channel list for use when determination is unavailable is created. The list includes, for example, only channels that are usable both indoors and outdoors. In step S521, the setting of maximum transmission power for use when determination is unavailable is performed. For example, a smaller one of the indoor maximum transmission power and the outdoor maximum transmission power is set as the determination-unavailable maximum transmission power. In step S522, a channel to be used when the communication apparatus 100 is started up as the access point is selected. In step S522, as in step S512, a configuration may be employed in which a channel having a high maximum transmission power among the usable channels is preferentially selected.

As described above, in the processing for setting the channel and the maximum transmission power, the channel usable as the access point, the maximum transmission power, and the channel to be preferentially used can be set from the accessory mount information. By the processing for setting the channel and the maximum transmission power, the communication apparatus 100 can operate as the access point in the appropriate channel at the maximum transmission power in accordance with the accessory to be used.

### Second Embodiment

In the first embodiment, the example in which the communication apparatus 100 operates as the access point is described.

In a second embodiment, an example in which the communication apparatus 100 operates in a station mode and the communication apparatus 110 operates in an access point mode is described. In the case of a station function, the channel to be used is a channel in which the access point operates, and the setting of the maximum transmission power is also applicable to the station function.

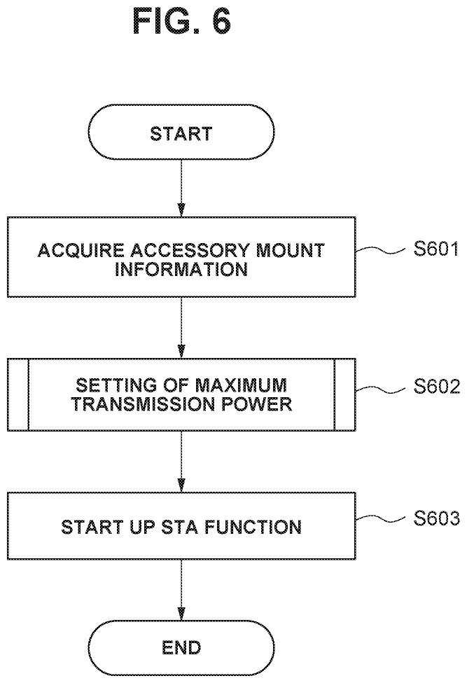

FIG. 6 is a flowchart in which the communication apparatus 100 operates in the station mode.

Processing in step S601 is processing for acquiring information on an accessory connected to the mount unit 208, and is similar to the processing in step S401. In step S602, setting of the maximum transmission power at which the station function is operable is performed in accordance with the mounted accessory. Details of the processing for setting the maximum transmission power are described below. In step S603, the station function is started up based on a setting value set in step S602.

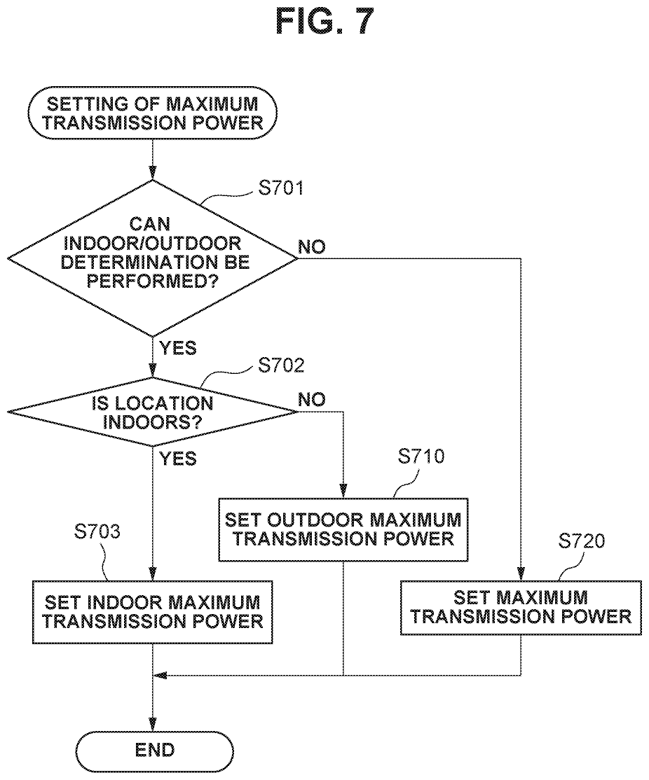

Subsequently, the processing for setting the maximum transmission power in step S602 is described in detail with reference to FIG. 7. In the processing for setting the maximum transmission power, in step S701, it is checked whether the indoor/outdoor determination can be performed based on the accessory mount information acquired in step S601. The details of the processing are similar to the details of the processing in step S501. In a case where the indoor/outdoor determination can be performed (YES in step S701), the processing proceeds to step S702. In a case where the indoor/outdoor determination cannot be performed (NO in step S701), the processing proceeds to step S720. In a case where it is determined in step S701 that the indoor/outdoor determination can be performed, in step S702, it is determined whether the communication apparatus 100 is used indoors or outdoors based on the accessory mount information. Details of the processing in step S702 are similar to the details of the processing in step S502. In a case where it is determined that the communication apparatus 100 is used indoors (YES in step S702), the processing proceeds to step S703. In a case where it is determined that the communication apparatus 100 is used outdoors (NO in step S702), the processing proceeds to step S710. In the case where it is determined that the communication apparatus 100 is used indoors, in step S703, setting of the indoor maximum transmission power is performed. In the case where it is determined that the communication apparatus 100 is used outdoors, in step S710, setting of the outdoor maximum transmission power is performed. In the case where it is determined in step S701 that the indoor/outdoor determination cannot be performed, in step S720, a smaller one of the outdoor maximum transmission power and the indoor maximum transmission power is set as the maximum transmission power.

As described above, in the processing for setting the maximum transmission power, the maximum transmission power as the station function can be set from the accessory mount information. By the processing for setting the maximum transmission power, the communication apparatus 100 can operate as a station in a state where appropriate maximum transmission power is set in accordance with the accessory to be used.

The disclosure is not limited to the embodiments described above, and various modifications and variations can be made without departing from the spirit and scope of the disclosure. Therefore, the appended claims are provided to make public the scope of the disclosure.

According to the present disclosure, it is possible to perform the indoor/outdoor determination of the communication apparatus in accordance with the accessory mounted on the communication apparatus and to perform an appropriate communication setting for the communication apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-051947, filed Mar. 26, 2025, which is hereby incorporated by reference herein in its entirety.

What is claimed is:

1. A communication apparatus, comprising:
a mounting reception unit configured to receive mounting of an accessory to the communication apparatus; and
a communication control unit configured to control a communication parameter in accordance with a predetermined accessory mounted to the communication apparatus.

2. The communication apparatus according to claim 1, wherein the communication parameter includes a usable channel and a maximum transmission power.

3. The communication apparatus according to claim 2, wherein the predetermined accessory is any of a motion capture sensor, a global positioning system (GPS) unit, an external antenna, or a protection unit.

4. The communication apparatus according to claim 3, further comprising a determination unit configured to determine that a location of the communication apparatus is indoors or that the location of the communication apparatus is outdoors based on the predetermined accessory mounted to the mounting reception unit.

5. The communication apparatus according to claim 4, wherein, in a case where the determination unit determines that the location of the communication apparatus is indoors, the communication control unit performs control such that a predetermined channel whose use outdoors is restricted is used.

6. The communication apparatus according to claim 4, wherein, in a case where the determination unit determines that the location of the communication apparatus is indoors, the communication control unit performs control such that a channel whose use outdoors is restricted is preferentially used.

7. The communication apparatus according to claim 1, wherein the communication control unit controls wireless communication complying with an Institute of Electrical and Electronics Engineers (IEEE) 802.11 standard.

8. The communication apparatus according to claim 1, wherein the mounting reception unit receives mounting of the accessory via electric connection or wireless communication.

9. A method for controlling a communication apparatus, the method comprising:
receiving mounting of an accessory to the communication apparatus; and
controlling a communication parameter in accordance with a predetermined accessory mounted to the communication apparatus.

10. A non-transitory computer-readable storage medium storing instructions that, when executed by a computer, cause the computer to perform a method for controlling a communication apparatus, the method comprising:
receiving mounting of an accessory to the communication apparatus; and
controlling a communication parameter in accordance with a predetermined accessory mounted to the communication apparatus.
